(19) United States
(12) Patent Application Publication
(10) Pub. No.: US 2023/0175781 A1
(43) Pub. Date: Jun. 8, 2023

(54) OXYGEN INJECTION FOR ALTERNATIVE FUELS USED IN CEMENT PRODUCTION

(71) Applicants: Messer Industries USA, Inc., Bridgewater, NJ (US); Messer Austria GmbH, Gumpoldskirchen (AT)

(72) Inventors: Andrew Richardson, Clinton, NJ (US); Reed A. Heine, Annandale, NJ (US); Kinshuk Verma, San Jose, CA (US); Martin Demuth, Guntramsdorf (AT)

(73) Assignees: Messer Industries USA, Inc., Bridgewater, NJ (US); Messer Austria GmbH, Gumpoldskirchen (AT)

(21) Appl. No.: 17/990,846

(22) Filed: Nov. 21, 2022

Related U.S. Application Data
(60) Provisional application No. 63/285,159, filed on Dec. 2, 2021.

(51) Int. Cl. F27D 99/00; F23L 7/00; F23B 30/00; F23B 90/04

(52) U.S. Cl. CPC F27D 99/0033; F23L 7/007; F23B 7/002; F23B 90/04; F23B 5/02; F27M 2003/03; F27D 2099/0051

(57) ABSTRACT

Provided is a system for enhancing combustion in a kiln, including a kiln combustion chamber disposed within the kiln, the kiln combustion chamber having an atmosphere therein; a main burner for heating the atmosphere; a calciner assembly for providing a substance to be heated into the kiln combustion chamber; a precalciner including a precalciner combustion chamber disposed within the precalciner for receiving a biomass fuel for combustion in the precalciner combustion chamber, the precalciner combustion chamber in communication with the kiln combustion chamber; and a precalciner oxygen injector in fluid communication with the precalciner combustion chamber for providing a first oxygen stream into the biomass fuel for the combustion. A related apparatus and method for enhancing combustion with oxygen and biomass fuel are also provided.

### BACKGROUND OF THE INVENTION

The present embodiments relate to use of oxygen to combust fuel for the production of cement in a production plant, the production plant having a rotary kiln and a calciner or preheating tower equipped with a precalciner and more particularly, to the addition of oxygen (O₂) to enhance combustion in the precalciner.

The production of cement and other materials, such as for example lime, dolomite, or other aggregates, occurs in a production plant which includes a rotary kiln. The rotary kiln often includes or is equipped with a calciner tower, otherwise known as a preheater tower. The calciner tower will usually include a precalciner, wherein a fuel and oxidant are combusted in both the kiln and the precalciner to ultimately produce clinker and subsequently cement. Lime kilns however often do not include a precalciner. The rotary kiln exhaust is used in the preheat or calciner tower for heat recovery from flue gases via the preheating of the raw feed materials or ‘meal’. The heat recovery occurs in a countercurrent manner through a cascade of cyclone separation units. The calciner tower includes the precalciner into which is fed additional energy to facilitate and promote decarbonization reactions of the meal prior to the meal being fed into the rotary kiln. The fuel used in the precalciner has been to date any known variety of fossil fuels such as for example natural gas, oil and/or coke. There is however a current need and desire, particularly in the United States, to increase the use of biomass fuels in order to reduce the carbon footprint that occurs when using more conventional fossil fuels for the precalciner.

Regarding biomass fuels, such fuels (a) typically have a lower calorific value than known fossil fuels currently being used, (b) are less reactive for combustion, and (c) are of variable quality including greater, and in some instances, variable moisture levels throughout the year. Therefore, the desire to switch to greater proportions of biomass fuel for combustion in a precalciner in order to reduce a carbon footprint of the production plant in which the kiln or rotary kiln and the precalciner are located have to date accordingly resulted in (i) poor or delayed ignition of the fuel introduced into the precalciner, (ii) lower temperatures in the precalciner with commensurate poor heating of the meal, and (iii) poor burn-out of the biomass fuel used in the precalciner and during entrained transport of the meal through a gooseneck section in fluid communication with a product inlet of the rotary kiln and an off-gas outlet of the rotary kiln. Excessive unburned fuel, whether a biomass fuel or otherwise, adversely impacts production and may result in an inferior product produced by the production plant.

It is known that increasing the proportion of oxygen in an oxidant used in a combustion system will increase the reaction rates, shorten ignition time and elevate temperature resulting from combustion in the system. Therefore, it would be desirable to increase the proportion of oxygen in an oxidant used for combustion in the precalciner in order to improve the ignition, increase the burn-out of the biomass fuel, and maintain process temperature and production continuity of the production plant.

### SUMMARY

There is therefore provided herein a system embodiment for enhancing combustion in a kiln, which includes: a kiln combustion chamber disposed within the kiln, the kiln combustion chamber having an atmosphere disposed therein; a main burner for heating the atmosphere; a calciner assembly for providing a substance to be heated into the kiln combustion chamber; a precalciner including a precalciner combustion chamber disposed within the precalciner for receiving a biomass fuel for combustion in the precalciner combustion chamber, the precalciner combustion chamber in communication with the kiln combustion chamber; and a precalciner oxygen injector in fluid communication with the precalciner combustion chamber for providing a first oxygen stream into the biomass fuel for combustion.

Another system embodiment further includes an ancillary oxygen injector for injecting a second oxygen stream into air heated near the main burner. The air may have been heated by hot clinker exiting the kiln combustion chamber near the main burner.

Another system embodiment further includes the ancillary oxygen injector constructed and arranged for the second oxygen stream to be injected, comprising a first stream portion at a first velocity, and a second stream portion at a second velocity not greater than or optionally lesser than the first velocity, the second stream portion shrouding at least part of the first stream portion.

Another system embodiment further includes a controller in operative association with the precalciner oxygen injector and the ancillary oxygen injector for controlling an amount of oxygen provided to each of the precalciner and the air heated near the main burner.

Another system embodiment further includes a tertiary air duct for receiving the air heated by the main burner with the second oxygen stream as preheated, oxygen enhanced tertiary air for delivery to the precalciner combustion chamber proximate the biomass fuel being introduced into precalciner combustion chamber or optionally proximate fuel introduced into the precalciner combustion chamber.

Another system embodiment calls for the tertiary air duct to further include a tertiary air branch interconnecting and in fluid communication with the tertiary air duct and an inlet to the precalciner for delivering the preheated, oxygen enhanced tertiary air to the precalciner combustion chamber.

Another system embodiment calls for including a dust box in fluid communication with the air heated near the main burner, and into which the ancillary oxygen injector is director is directed for injecting the second oxygen stream.

Another system embodiment calls for a longitudinal axis of the ancillary oxygen injector being in registration with another longitudinal axis of the tertiary air duct.

Another system embodiment calls for the biomass fuel to be selected from the group consisting of nut shells, wood chips, wood pellets, sawdust, bark, straw, rice husks, sun flower seed husks, and combinations thereof.

Another system embodiment calls for an alternative fuel to be substituted for the biomass fuel, the alternative fuel selected from the group consisting of waste derived fuel from industrial waste, waste derived fuel from municipal waste, oil polluted waste, petroleum products, petroleum coke, plastics, shredded tires, cut tires, and combinations thereof.

Another system embodiment calls for a sensor operatively associated with the precalciner for sensing a temperature within the precalciner combustion chamber.

Another system embodiment calls for the kiln to include a rotary kiln or optionally a rotary kiln of a production plant.

There is also provided herein an apparatus embodiment for enhancing combustion in a precalciner of a kiln, which includes: a precalciner oxygen injector in fluid communication with a precalciner combustion chamber art an interior of the precalciner, the precalciner combustion chamber constructed and arranged to receive a biomass fuel into which is delivered an oxygen stream from the precalciner oxygen injector of combustion of the biomass fuel.

Another apparatus embodiment further includes: an ancillary oxygen injector for delivering an ancillary oxygen stream into heated air near a main burner of the kiln; and a tertiary air duct in fluid communication with the heated air for delivering the heated, oxygen enhanced air to the interior of the precalciner.

Another apparatus embodiment further includes a controller operatively associated with the precalciner oxygen injector and the ancillary oxygen injector for controlling an amount of oxygen provided to each of the precalciner and the heated air.

Another apparatus embodiment includes a longitudinal axis of the ancillary oxygen injector being in registration with another longitudinal axis of the tertiary air duct.

Another apparatus embodiment further includes the biomass fuel selected from the group consisting of nut shells, wood chips, wood pellets, sawdust, bark, straw, rice husks, sun flower seed husks, and combinations thereof.

Another apparatus embodiment further includes an alternative fuel substituted for the biomass fuel or optionally wherein the alternative fuel is included with the biomass fuel, the alternative fuel selected from the group consisting of waste derived fuel from industrial waste, waste derived fuel from municipal waste, oil polluted waste, plastics, petroleum products, petroleum coke, shredded tires, cut tires, and combinations thereof.

Another apparatus embodiment calls for a sensor operatively associated with the precalciner for sensing a temperature within the precalciner combustion chamber.

Another apparatus embodiment calls for the kiln to include a rotary kiln or alternatively a rotary kiln of a production plant.

There is also provided herein a method embodiment for enhancing combustion in a precalciner of a kiln, which includes: providing a biomass fuel into the precalciner; and delivering an oxygen stream into the precalciner for combusting the biomass fuel.

Another method embodiment further includes delivering an ancillary oxygen stream into heated air near a main burner of the kiln for providing a heated, oxygen enhanced tertiary air stream; and delivering the heated, oxygen enhanced tertiary air stream through a duct into the precalciner for the combusting.

Another method embodiment further includes controlling an amount of the oxygen stream being delivered to the precalciner, and an amount of the ancillary oxygen stream being delivered to the heated air near the main burner.

Another method embodiment further includes delivering the oxygen stream at a location in the precalciner upstream of ignition for the combusting.

Another method embodiment further includes the biomass fuel selected from the group consisting of nut shells, wood chips, wood pellets, sawdust, bark, straw, rice husks, sun flower seed husks, and combinations thereof.

Another method embodiment further includes an alternative fuel is substituted for the biomass fuel or optionally wherein the alternative fuel is included with the biomass fuel, the alternative fuel selected from the group consisting of waste derived fuel from industrial waste, waste derived fuel from municipal waste, oil polluted waste, petroleum products, petroleum coke, plastics, shredded tires, cut tires, and combinations thereof.

Another method embodiment calls for the kiln to include a rotary kiln positioned in a production plant.

Another method embodiment further includes the kiln producing a substance selected from the group consisting of cement, lime, kaolin, magnesite, dolomite, and other substances used in refractory industries.

### BRIEF DESCRIPTION OF THE DRAWINGS

For a more complete understanding of the present invention, reference may be had to the following description of exemplary embodiments considered in connection with the accompanying drawing Figures, of which:

FIG. 1 shows a schematic view of a known cement production process including a rotary kiln, calciner or preheat tower, and a precalciner, for example.

FIG. 2 shows a schematic view of the known cement production process of FIG. 1 now having the oxygen injection embodiments of the present invention included therein,

FIG. 3 shows a schematic view with more particularity of the inventive oxygen injection embodiments of FIG. 2.

FIGS. 4A and 4B show schematic views of oxygen injection embodiments mounted for operation with a precalciner of the rotary kiln at a fuel feed and an injection zone, respectively, of the precalciner.

FIGS. 4C-4E show schematic views of an oxygen lance used in the precalciner of the oxygen injection embodiments of FIGS. 4A and 4B.

FIG. 5 shows a schematic view of an oxygen lance mounted for operation with a dust box of the rotary kiln in FIGS. 2 and 3 for oxygen injection.

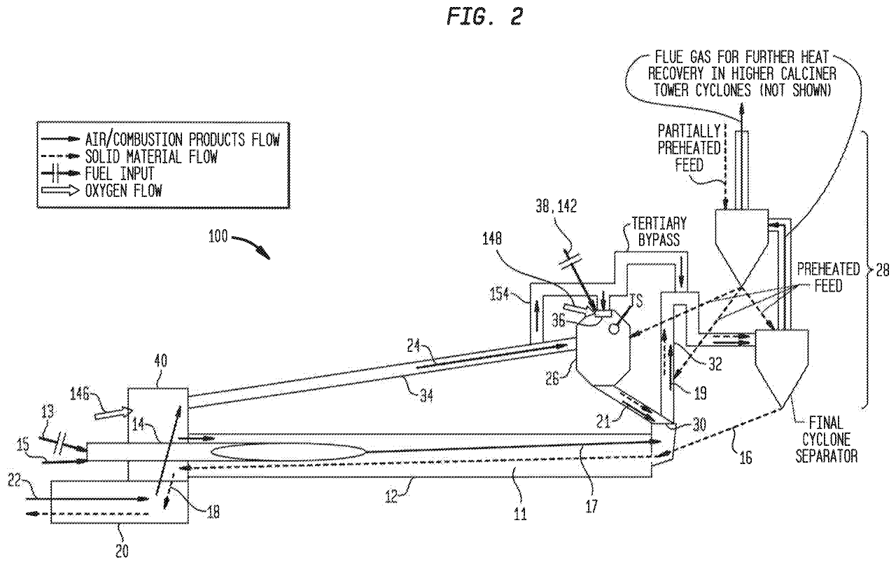

In summary, FIGS. 2-5 show schematic views of the inventive oxygen injection embodiments mounted for operation with a precalciner and a dust box of the rotary kiln.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the inventive embodiments and should not be taken as words of limitation. The drawings are for the purpose of illustrating the inventive embodiments, and neither the drawings nor the elements shown therein are intended to be to scale.

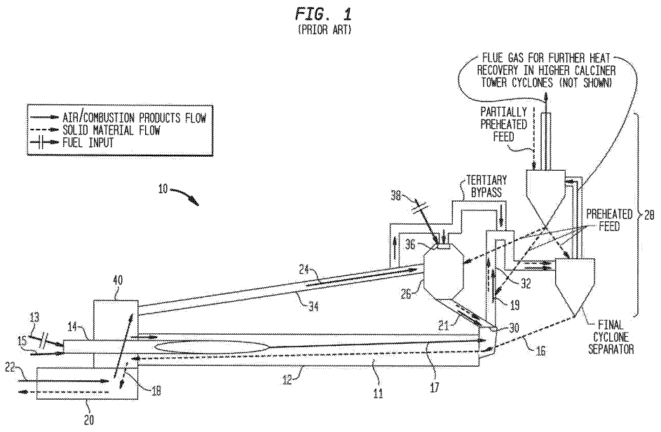

The description below of FIG. 1 provides context to better understand the inventive embodiments of FIGS. 2-5. FIG. 1 is a view of a known production plant 10 used to produce clinker for cement manufacture, for example. Other substances produced by the production plant 10 may include lime, kaolin, magnesite, dolomite and other mixtures and products used in the refractory industry. A legend is provided showing flow and input of: air/combustion products flow; solid material flow; and fuel input.

A rotary kiln 12 of the production plant 10 is basically a cylindrical combustion chamber 11 in the form of a brick-lined steel shell that rotates about its longitudinal axis approximately one to five times every minute. The chamber may be up to several hundred feet long and exceed twelve feet (12′) in diameter. The rotary kiln 12 is positioned so that its longitudinal axis is at a slight incline or angle, with a main burner 14 mounted at its lower (proximal) end such that the rotary kiln fires substantially along the longitudinal axis. A main burner fuel input 13 and a main burner air input 15 are each connected to the main burner 14 for providing burner fuel and burner air, respectively, to the main burner. Rotation of the rotary kiln 12 causes the meal to be mixed and homogenized as the meal gradually moves along the combustion chamber 11 of the rotary kiln. The meal is heated and thermally reacted to form ‘clinker’ (the clinker phase) 18 as the clinker moves from a feed inlet 16 at an opposite (distal) end of the rotary kiln 12 to the proximal end of the rotary kiln at which end the clinker drops out at full heated temperature from the rotary kiln into a product cooler 20. During the actual dropping from the kiln 12, the clinker 18 is cooled and cools further upon entry into the product cooler 20. During the cooling process, secondary air 22 introduced into the kiln main burner 14 and tertiary air 24 for the precalciner 26 are each preheated by contact with the clinker product 18 that has dropped out from the combustion chamber 11 to be cooled.

The meal enters the rotary kiln 12 via the calciner 28 or calciner tower. In the calciner tower 28, hot gases exhausted from the rotary kiln 12 pass through to the calciner tower to be used to heat the raw meal. More particularly, off-gas 17 from the kiln 12 goes directly to the calciner tower 28, e.g., first through an orifice 30 and then as indicated by arrow 19 through a gooseneck 32. A tertiary air duct 34 houses and directs preheated tertiary air 24 from the product cooler 20 to the precalciner 26. The off-gas 21 from the precalciner 26 comes into contact with the off-gas 17 from the rotary kiln 12 after the orifice 30 to provide an off-gas mixture 19 which then passes through the gooseneck 32. The off-gas mixture 19 is provided to the raw meal in a final cyclone separator of the calciner tower 28 to pre-heat the raw meal. As a result, the raw meal is already heated and at least partially reacted before it enters the rotary kiln 12 at that feed inlet 16. The raw meal is formed from a blend of ground raw materials such as for example limestone and shale.

The calciner tower 28 includes the precalciner 26 into which preheated meal is fed. Additional combustion energy is applied to the meal by a precalciner burner 36 with a fuel 38 and the hot tertiary air 24 preheated by contact with the hot product or clinker 18 exiting the main burner 14 (proximal) end of the rotary kiln 12. The hot tertiary air 24 is collected in a dust box 40 and transported to the precalciner 26 via the tertiary air duct 34. The calciner 28, and the precalciner 26 with its burner 36, substantially completes the decarbonization reactions of the meal prior to its entry into the rotary kiln 12.

However, the above known system and method are improved by the oxygen injection embodiments of the present invention described below for use with alternative fuels such as biofuels used in a rotary kiln. The embodiments call for oxygen enhancement and include: Embodiment (1) split oxygen (O₂) enhancement for solid material processing; Embodiment (2) diffuse oxygen injection for solid fuel combustion enhancement; and Embodiment (3) a robust oxygen injector for aggressive environments.

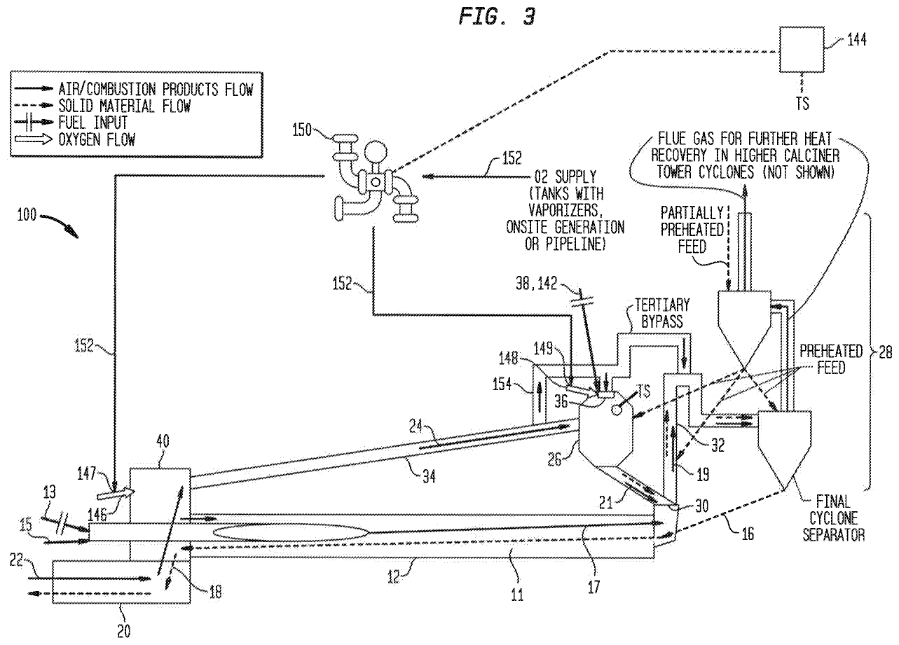

### Embodiment 1, FIGS. 2-3: Split Oxygen Enhancement for Solid Material Processing

A legend is provided in FIGS. 2-3 showing flow and input of: air/combustion products flow; solid material flow; fuel input; and oxygen flow. Controlled supply of oxygen (O₂) is shown to the precalciner 26 between general oxygen enrichment in the preheated tertiary air supply 24 and oxygen injection proximate the solid fuel/biomass fuel supply 142.

Supplying at least some of the oxygen into the region of the solid fuel/biomass fuel feed discharge of the precalciner 26 provides a higher oxygen concentration locally where the solid fuel/biomass fuel enters the precalciner, than in the bulk of the preheated tertiary air 24 to the precalciner, thereby allowing for greater impact on the ignition of the solid fuel/biomass in the precalciner.

Not all the oxygen must be fed proximate an inlet of the precalciner 26 for the solid fuel/biomass fuel 142, because excessive oxygen concentrations could produce locally elevated temperatures. As such, it is desirable to be able to control a split or separation of oxygen from general enrichment to that of targeted enrichment near the solid/biomass fuel inlets in order to control combustion and related process conditions.

As shown in FIGS. 2 and 3, a system 100, which also includes a related apparatus and method, consists of a controller 144 to control a plurality of flows (two flows, for example) of oxygen to two separate oxygen injectors: a first oxygen injector 146 positioned at the dust box 40 (i.e., a ‘robust’ oxygen injector), and a second oxygen injector 148 positioned at the precalciner 26 (i.e., a ‘diffuse’ oxygen injector). Oxygen enrichment is therefore being provided to the dust box 40 and the precalciner 26. The robust oxygen injector 146 at the dust box 40 and proximate to the main burner 14 provides oxygen to air in the dust box that is heated by the clinker 18 and, as shown in FIGS. 2-3, the resulting airflow becomes the hot or preheated oxygen enriched tertiary air 24 delivered in the corresponding tertiary air duct 34 to the precalciner burner 36 of the precalciner 26. A flow train 150 of the controller 144 provides safety functions, including automatic oxygen shut-off valves activated by excessive process deviations such as pressures, flows, temperatures, process interlocks and emergency stops. To modulate and measure the flows, the flow train 150 also includes inlet pressure regulation, flow meters and flow control valves connected to the process control system.

The total oxygen flow to the system 100 is determined to maintain available heat to the system while limiting the off-gas volumes. With the utilization of lower calorific fuels, the volumetric flow of off-gas rises because of the following mechanisms:
Higher content of moisture leads to more water vapor.
Lower calorific value leads to higher specific energy consumption requiring more fuel for the same production rate.
   This leads to the following effects:
Higher load on the off-gas system. In particular, the ID (induced draft) fan, which draws air into and combustion products through the combustion chamber 11 of the rotary kiln 12, precalciner 26 and calciner tower 28, is often at the limit.
Higher amount of combustion air being needed, which is coming from the suction of the ID fan together with fans for the product cooler 20.
Lower combustion temperature, which could lead to a potential incomplete burnout, which manifests as unburned solid fuel residue and unburned gaseous combustion products such as carbon monoxide (CO) and volatile organic compounds (VOC) in the off-gas, leading to excessive emissions of said products of incomplete combustion. Low combustion temperatures may further reduce heat transfer rates and production rates.

Oxygen supplementation to or enhancement of the combustion air will lessen these earlier recited adverse effects, as all modern cement plants are driven stoichiometrically by off-gas composition measurements, thereby influencing suction of the ID fan (not shown) at the calciner tower exhaust or flue gas and therefor, influencing air intake all the way to the product cooler section. By injecting oxygen, the combustion air flow is reduced accordingly by the production plant automation system to maintain the desired off-gas residual oxygen concentration. This results in a lowered amount of ballast nitrogen in the combustion oxidizer (mix of air and oxygen) and off-gas. Additionally, the combustion can be influenced by a prompt ignition, thereby beneficially increasing the temperature and influencing the residence time for the burnout.

A temperature sensing “TS” element or temperature sensor, such as a thermocouple or a pyrometer, located at the precalciner 26 near the fuel/biomass fuel inlet 38,142 is used to measure the temperature within the precalciner proximate the inlet for the fuel/biomass fuel into the precalciner. This temperature is representative of any one of the following in the precalciner: poor combustion, existence and status of ignition, adequate combustion and/or excessive temperatures. A temperature setpoint within a temperature range is determined by previous satisfactory operation of the precalciner 26. The proportion of the total oxygen delivered to the system 100 and which is delivered to the precalciner 26 is responsive to a deviation from the setpoint's desired temperature, i.e., if the precalciner temperature is too low, the proportion of oxygen delivered to the precalciner is increased; if the precalciner temperature is too high, the proportion of oxygen delivered to the precalciner is reduced. In this way of construction and operation, and during instances of poor ignition, slow combustion or lower flame temperatures due to an increase in biomass fuel flow or a decrease in biomass fuel quality, i.e., a different type, batch or moisture level, the flow of oxygen directly to the precalciner 26 near the fuel discharge inlet is increased and the combustion promoted by the locally increased oxygen concentrations.

Pressure transmitters 147,149 can be positioned immediately upstream of oxygen lances 146,148, respectively, for the oxygen flow 152 enhancement and are located near each injector inlet; the outputs of which are continuously monitored together with flow rate to determine any deviation from intended and historic values which would indicate a blockage, wear or failure in the respective lances.

The controller 144 or control routine is in communication with the oxygen flow 152 of the flow train 150, each temperature sensor TS, and flow meters and control valves of the oxygen flow-train. The controller 144 maintains the total oxygen flow at the desired oxygen flow setpoint and determines the actual flows to each injector 146,148 (the injector 146 at the dust box 40, and the injector 148 at the precalciner 26) based upon the temperature deviation between the temperature indicated by TS and the desired set point temperature of the precalciner 26. As the temperature at the TS falls below the setpoint temperature, the controller 144 instructs the oxygen flow train 150 control valves to deliver a greater oxygen flow to the precalciner diffuse oxygen injector 148 and less to the robust (dust box) injector 146, thereby maintaining a constant total oxygen flow 152 at the desired total oxygen flow setpoint. Conversely, if the temperature at TS rises above the setpoint temperature range, the controller 144 instructs the oxygen flow 152 of the flow train 50 control valves to deliver a smaller oxygen flow to the precalciner diffuse oxygen injector 148 and a greater oxygen flow to the robust dust box injector 146, thereby maintaining a constant total oxygen flow at the desired total oxygen flow setpoint. Advantageously, a range or a dead band is a range in which the controller 144 takes no action, i.e., the controller only makes a change when the temperature rises above or falls below the upper or lower limits of the dead band range around the desired setpoint so as to prevent frequent flow changes for only small temperature deviations. Such control functions are readily achievable with known industrial controllers such a programmable-logic-controllers (PLC), distributed control systems (DCS) or microprocessor-based controls incorporating functions such as proportional-integral-derivative (PID) loop, on-off and dead-band functions.

The system 100 may also include a tertiary air branch 154 interconnecting and in fluid communication with the tertiary air duct 34 and an inlet to the precalciner 26 for delivering hot oxygen enriched tertiary air 24, which has been preheated, to a combustion chamber within the precalciner.

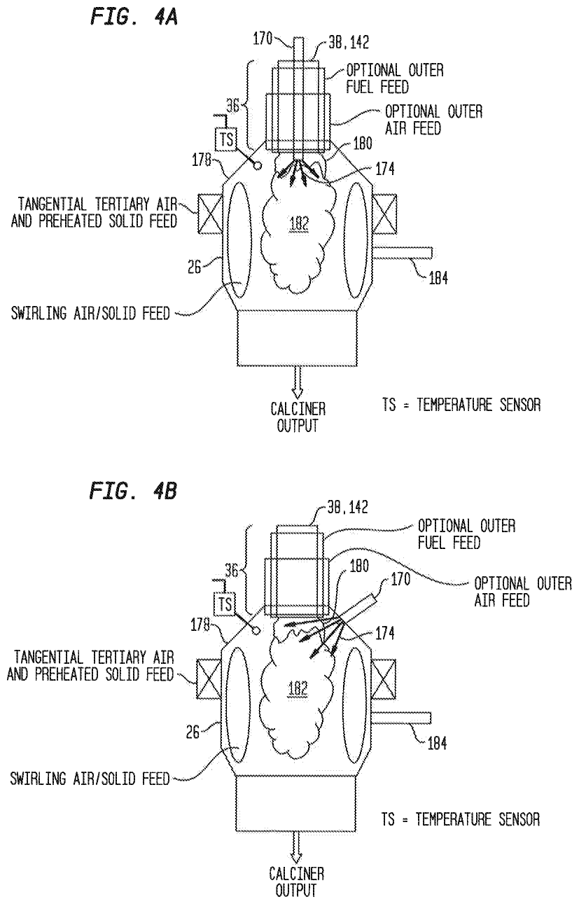

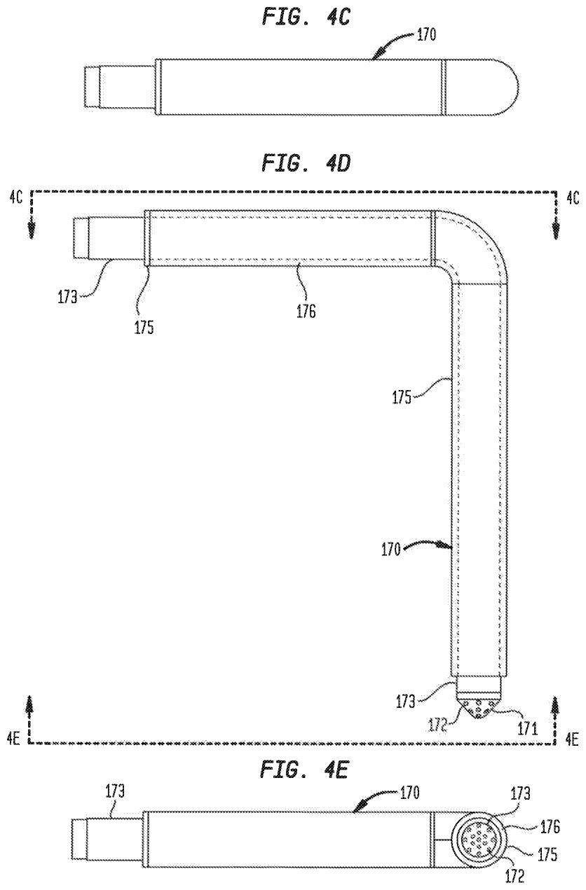

### Embodiment 2, FIGS. 4A-4E: Diffuse Oxygen Injection for Solid Fuel Combustion Enhancement

An oxygen injector 170 is constructed and arranged to be positioned through the solid fuel inlet to the precalciner 26 and terminate proximate the discharge of the solid fuel inlet into the precalciner (see FIG. 4A). A nozzle 171 (FIG. 4D) of the injector 170 may be conical in shape and includes a plurality of holes 172 or apertures to generate a spray 174 of oxygen into the stream of solid fuel/biomass fuel 38,142, thus enriching the region or path with oxygen into which the solid fuel is introduced into the precalciner 26.

The targeted enrichment of oxygen around the solid fuel/biomass fuel 38,142 allows for greater impact on the combustion process by elevating the local oxygen concentrations introduced into the combustion process than would otherwise occur by merely just enriching an amount of air supplied to the process.

In the present inventive embodiments, as the oxygen injector 170 may be located within the solid biomass fuel feed passage there may be concern about wear on or abrasion of the (high pressure) oxygen feed pipe to the nozzle. Accordingly, a wear shield 175 shown in FIGS. 4D and 4E is mounted around the oxygen injector 170 to protect the inner oxygen feed from excessive wear.

An air purge stream 176 flows in the annular gap between an inner oxygen feed 173 of the injector 170 and the outer wear shield 175, the stream 176 discharging around the nozzle 171 to afford external gas shield protection to the nozzle when the injector 170 is inserted into the precalciner 26.

FIG. 4B shows an alternate location of the diffuse oxygen injector 170 in the upper conical section 178 of the precalciner 26 angled inwards to immediately face downstream of the solid biomass fuel feed passage. While such an arrangement is less invasive on the solid biomass fuel feed passages and may not suffer as much wear from the solid biomass fuel combustion, some dilution and deflection of the injected oxygen may occur and, as such, it is likely to be less effective at locally enriching the initial region of the biomass fuel flame with oxygen. Embodiment 2 shown in FIGS. 4A-4B, includes a pre-ignition zone 180 and a combusting fuel zone 182. Each precalciner 26 of the Embodiment 2 may also include a secondary burner 184 as shown to facilitate combustion in the combusting fuel zone 182 within the precalciner. A temperature sensor TS may also be provided proximate the upper conical section 178 as shown in the embodiments of FIGS. 4A and 4B.

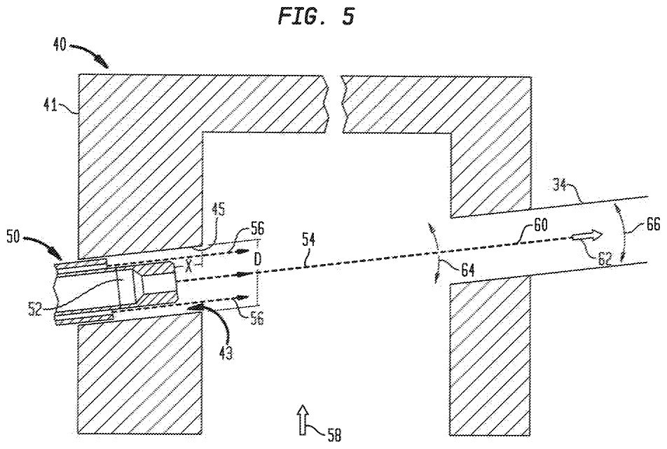

### Embodiment 3, FIG. 5: Robust Oxygen Injector for Aggressive Environments

Referring to FIG. 5 and in conjunction therewith FIGS. 2 and 3, an oxygen injector 50 for the oxygen flow from the first oxygen injector 146 includes a nozzle 52, with the injector mounted in a recess 43 or hole of a wall 41 of the dust box 40 so that the nozzle is positioned in the recess. The oxygen injector 50 extends substantially in a direction toward and parallel to an axial length of the tertiary air duct 34. That is, a central longitudinal axis of the nozzle 52 is co-axial or at least substantially co-axial with a central longitudinal axis of the tertiary air duct 34, as further described below. A high velocity oxygen stream 54 or jet is emitted from a central or first passage of the nozzle 52, with an oxygen shroud 56 emitted from an outer or second passage of the injector 50 about the stream 54 at a velocity lower than that of the stream 54. The lower velocity oxygen shroud 56 from the outer passage also flows over an outer surface of the nozzle 52, as shown in FIG. 5, thereby providing direct protection against abrasion to the nozzle. The high velocity oxygen stream 54 from the central passage initially entrains the lower velocity oxygen shroud 56, instead of entraining hot particle-laden preheated air 58 in the dust box 40, thus reducing, as mentioned above, direct abrasion of the nozzle 52 from hot particulate matter entrained within the atmosphere of the dust box.

As also shown in FIG. 5, the oxygen injector 50 with the nozzle 52 (of the first oxygen injector 146) is positioned within the recess 43 in the wall 41 of the dust box 40 at a distance “X” equal to or substantially equal to a diameter “D” of the recess. In other words, a discharge end or tip of the nozzle 52 is disposed within the recess 43 to a distance X equal to or substantially equal to a diameter D of the recess. The low velocity oxygen shroud 56 allows the inner (central) high velocity oxygen stream 54 to propagate freely without interference from an inner surface 45 of the hole 43 which would otherwise decay the stream 54 and abrade a sidewall of the hole.

Oxygen delivered to both the low velocity (outer) oxygen shroud 56 and the high velocity (inner) oxygen stream 54 can be provided from a common oxygen source or supply (not shown), such as a tank or pipeline, and thereafter directed or split to each of the stream 54 and the shroud 56 by the injector 50 and the nozzle 52.

The high velocity oxygen stream 54 is preferably directed towards a longitudinal axis 60 of the tertiary air duct 34 enroute to the precalciner 26, as shown by arrow 62. Such an arrangement provides for a direct, efficient delivery of hot oxygen enriched tertiary air to and through the tertiary air duct 34. Alternatively, the longitudinal axis of the oxygen injector 50 and/or the nozzle 52, and/or the recess 43 may be somewhat tilted or angled (i.e. no longer co-axial) with respect to the longitudinal axis 60 of the tertiary air duct 34; or the velocities of the oxygen stream 54 and the oxygen shroud 56 may be varied, thereby causing the oxygen stream 54 enroute to the precalciner 26 to deviate up to as much as ten (10) degrees from the longitudinal axis 60 of the tertiary air duct 34, as shown by angled arrows 64,66.

Further advantages of the Embodiments 1-3 described above also include:

Embodiment 1. Split Oxygen Enhancement for Solid Material Processing: the ability to (a) increase the proportion of biomass fuel fired in the precalciner 26, (b) increase the proportion of biomass fuel fired to a greater extent while using a given amount of oxygen by preferentially enriching the ignition region of the biomass fuel inlet to the precalciner 26, (c) control the local combustion conditions by controlling the split or allocation of oxygen flow targeted directly around the biomass fuel and to general enrichment in order to achieve reliable and selected ignition, while also avoiding localized overheating of the precalciner burner 36, and the upper conical section 178 of the precalciner 26, and (d) react to changing biomass fuel feed quantity, type and/or quality.

Embodiment 2, Diffuse Oxygen Injection for Solid Fuel Combustion Enhancement: (a) improved effect of using oxygen, i.e., provides for oxygen to be targeted to where it is most needed for the precalciner 26 and dust box 40 applications, (b) able to introduce oxygen to existing solid fuel/biomass fuel feed streams 38,142 or to an interior side or sides of the precalciner 26, wherein there is a heated air-meal stream swirling around cylindrical walls of the precalciner, wherein such an environment is not only challenging from its high temperature abrasive nature and tendency to plug injectors, but also tends to cause the injected oxygen to be deflected into the swirling air-meal stream instead of the desired penetration into a central combustion region 182, (c) creates localized enrichment in a zone within a solid fuel stream resulting in improved ignition conditions and subsequent combustion, and (d) enhances ignition and combustion results in greater proportions of the biomass fuel able to be delivered through the solid fuel/biomass fuel feed streams 38,142 into the precalciner 26.

Embodiment 3. Robust Oxygen Injector for Aggressive Environments: (a) an unobtrusive embodiment to introduce an oxygen stream into an aggressive environment for enrichment of the environment for combustion, (b) avoids the need for a large diffuser to be mounted across the tertiary air duct 34, thereby resulting in lower cost and ease of installation than that of large diffusers spanning the tertiary air duct, which must be of construction strong enough to support its weight and remain protected from the abrasive hot dust carried with the preheated air, (c) reduced maintenance from wear or blockage to the injector 50,146, and (d) lower costs than would occur with larger known diffusers.

A wide range of biomass 142 may be combusted in the precalciner 26, and such biomass can include, but is not limited to nut shells, wood chips, wood pellets, sawdust, bark, straw, rice husks and sun flower seed husks. Alternative fuels other than biomass may be used to reduce and therefore improve the carbon footprint of the kiln 12 and production plant 10 at large, such as waste derived fuels from industrial facilities and municipalities, oil polluted waste, petroleum products, petroleum coke, plastics, shredded or cut tires, and combinations thereof. Such alternative fuels may function as CO₂-certificate emission free alternatives to biomass.

It will be understood that the embodiments described herein are merely exemplary and that a person skilled in the art may make variations and modifications without departing from the spirit and scope of the invention. All such variations and modifications are intended to be included within the scope of the invention described herein and provided in the appended claims. It should be understood that the embodiments described above are not only in the alternative but can be combined.

What is claimed is:

1. A system for enhancing combustion in a kiln, comprising:
a kiln combustion chamber disposed within the kiln, the kiln combustion chamber having an atmosphere therein;
a main burner for heating the atmosphere;
a calciner assembly for providing a substance to be heated into the kiln combustion chamber;
a precalciner including a precalciner combustion chamber disposed within the precalciner for receiving a biomass fuel for combustion in the precalciner combustion chamber, the precalciner combustion chamber in communication with the kiln combustion chamber; and
a precalciner oxygen injector in fluid communication with the precalciner combustion chamber for providing a first oxygen stream into the biomass fuel for the combustion.

2. The system of claim 1, further comprising an ancillary oxygen injector for injecting a second oxygen stream into air heated near the main burner.

3. The system of claim 2, wherein the ancillary oxygen injector is constructed and arranged for the second oxygen stream to be injected comprising a first stream portion at a first velocity, and a second stream portion at a second velocity not greater than or optionally lesser than the first velocity, the second stream portion shrouding at least part of the first stream portion.

4. The system of claim 2, further comprising a controller in operative association with the precalciner oxygen injector and the ancillary oxygen injector for controlling an amount of oxygen provided to each of the precalciner and the air heated near the main burner.

5. The system of claim 4, further comprising a tertiary air duct for receiving the air heated by the main burner with the second oxygen stream as preheated, oxygen enhanced tertiary air for delivery to the precalciner combustion chamber proximate the biomass fuel.

6. The system of claim 5, wherein the tertiary air duct further comprises a tertiary air branch interconnecting and in fluid communication with the tertiary air duct and an inlet to the precalciner for delivering the preheated, oxygen enhanced tertiary air to the precalciner combustion chamber.

7. The system of claim 2, further comprising a dust box in fluid communication with the air heated near the main burner, and into which the ancillary oxygen injector is directed for injecting the second oxygen stream.

8. The system of claim 7, wherein a longitudinal axis of the ancillary oxygen injector is in registration with another longitudinal axis of the tertiary air duct.

9. The system of claim 1, wherein the biomass fuel is selected from the group consisting of nut shells, wood chips, wood pellets, sawdust, bark, straw, rice husks, sun flower seed husks, and combinations thereof.

10. The system of claim 1, wherein an alternative fuel is substituted for the biomass fuel or optionally wherein the alternative fuel is included with the biomass fuel, the alternative fuel selected from the group consisting of waste derived fuel from industrial waste, waste derived fuel from municipal waste, oil polluted waste, petroleum products, petroleum coke, plastics, shredded tires, cut tires, and combinations thereof.

11. The system of claim 1, further comprising a sensor operatively associated with the precalciner for sensing a temperature within the precalciner combustion chamber.

12. The system of claim 1, wherein the kiln comprises a rotary kiln or optionally a rotary kiln of a production plant.

13. An apparatus for enhancing combustion in a precalciner of a kiln, comprising:
a precalciner oxygen injector in fluid communication with a precalciner combustion chamber at an interior of the precalciner, the precalciner combustion chamber constructed and arranged to receive a biomass fuel into which is delivered an oxygen stream from the precalciner oxygen injector for combustion of the biomass fuel.

14. The apparatus of claim 13, further comprising
an ancillary oxygen injector for delivering an ancillary oxygen stream into heated air near a main burner of the kiln; and
a tertiary air duct in fluid communication with the heated air for delivering the heated, oxygen enhanced air to the interior of the precalciner.

15. The apparatus of claim 14, further comprising a controller operatively associated with the precalciner oxygen injector and the ancillary oxygen injector for controlling an amount of oxygen provided to each of the precalciner and the heated air.

16. The apparatus of claim 14, wherein a longitudinal axis of the ancillary oxygen injector is in registration with another longitudinal axis of the tertiary air duct.

17. The apparatus of claim 13, wherein the biomass fuel is selected from the group consisting of nut shells, wood chips, wood pellets, sawdust, bark, straw, rice husks, sun flower seed husks, and combinations thereof.

18. The apparatus of claim 13, wherein an alternative fuel is substituted for the biomass fuel or optionally wherein the alternative fuel is included with the biomass fuel, the alternative fuel selected from the group consisting of waste derived fuel from industrial waste, waste derived fuel from municipal waste, oil polluted waste, petroleum products, petroleum coke, plastics, shredded tires, cut tires, and combinations thereof.

19. The apparatus of claim 13, further comprising a sensor operatively associated with the precalciner for sensing a temperature within the precalciner combustion chamber.

20. A method for enhancing combustion in a precalciner of a kiln, comprising:
providing a biomass fuel into the precalciner; and
delivering an oxygen stream into the precalciner for combusting the biomass fuel.

21. The method of claim 20, further comprising:
delivering an ancillary oxygen stream into heated air near a main burner of the kiln for providing a heated, oxygen enhanced tertiary air stream; and
delivering the heated, oxygen enhanced tertiary air stream through a duct into the precalciner for the combusting.

22. The method of claim 21, further comprising controlling an amount of the oxygen stream being delivered to the precalciner, and an amount of the ancillary oxygen stream being delivered to the heated air near the main burner.

23. The method of claim 20, wherein the delivering the oxygen stream is at a location in the precalciner upstream of ignition for the combusting.

24. The method of claim 20, wherein the biomass fuel is selected from the group consisting of nut shells, wood chips, wood pellets, sawdust, bark, straw, rice husks, sun flower seed husks, and combinations thereof.

25. The method of claim 20, wherein an alternative fuel is substituted for the biomass fuel or optionally wherein the alternative fuel is included with the biomass fuel, the alternative fuel selected from the group consisting of waste derived fuel from industrial waste, waste derived fuel from municipal waste, oil polluted waste, petroleum products, petroleum coke, plastics, shredded tires, cut tires, and combinations thereof.

26. The method of claim 20, further comprising producing a substance selected from the group consisting of cement, lime, kaolin, magnesite, dolomite, and other substances used in refractory industries from the combusting the biomass fuel.
